(19) United States
(12) Patent Application Publication
(10) Pub. No.: US 2007/0278781 A1
(43) Pub. Date: Dec. 6, 2007

(54) Spray Prevention Device

(76) Inventor: John Anthony Downes, Raby Mere (GB)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 10/599,623

(22) PCT Filed: Apr. 4, 2005
(86) PCT No.: PCT/GB05/01292

§ 371 Date: Jul. 7, 2007

(30) Foreign Application Priority Data
Apr. 3, 2004 (GB) 0407653.5

(51) Int. Cl. B62D 25/18

(52) U.S. Cl. 280/851

(57) ABSTRACT

A device for preventing spray from emerging from the wheels of vehicles comprises a panel (4) that is adapted to be mounted substantially vertically behind a vehicle wheel (3) for receiving on a first side water released by the wheel (3) as it rotates. The panel (4) includes at least one passage (6) which leads from the first side to a rear second side of the panel (4). The or each passage (6) is other than normal to the plane of the panel (4). There is at least one water-collecting pocket (7A, 7B, 7C) along the side of the or each passage (6). In use, air and water enter the or each passage (6) and are separated so that air passes through the or each passage (6) and mixes with ambient air and water collects in the at least one water-collecting pocket (7A, 7B, 7C).

The present invention relates to a device to prevent spray from emerging from the wheels of vehicles travelling along roadways in wet weather.

When vehicles (particularly large vehicles such as lorries) travel along a roadway in wet weather, a spray or mist is generated by the wheels which can seriously impair the vision of drivers of vehicles behind. This is very dangerous and can lead to accidents.

This spray occurs because water on the road is picked up by the rotating tyres and thrown off against the wheel arch. As the water hits the wheel arch, so the water is broken up into small droplets and atomised in the air to create a fine spray or mist. This spray is then ejected sideways out of the wheel arch. In extreme conditions, this spray can be impossible to see through.

It has been known to try and reduce such a spray by lining the rear of a wheel arch with a flap with surface bristles or a mesh which helps to cushion or reduce reflection of the water as it emerges from the wheel. This helps to reduce the break up of water into small particles. This does not however separate the water from the air.

UK Patent Specification 2229689 describes a spray inhibiting wheel guard. This wheel guard is curved to form the rear half of a wheel arch, and consists of a series of longitudinal channels between baffles to guide water out of the wheel arch area and direct it back onto a roadway. It has been found that this arrangement does not work since, when the vehicle is travelling at speed, air is forced into the upper area of the channels creating a back pressure in the channels by travelling down the pockets which prevents the spray from entering the channels.

The present invention seeks to provide a solution to this problem by separating the water from the air in the spray rather than trying to inhibit its formation.

According to the present invention there is provided a device to prevent spray from emerging from the wheels of vehicles travelling along roadways in wet weather said device comprising a panel for mounting generally vertically behind the wheel of a vehicle to receive on a first side of the panel water released by the wheel as it rotates, said panel including at least one passage which leads from the first side to a rear second side of the panel, the or each passage being other than normal to the plane of the panel, and at least one water-collecting pocket along the side of each passage, in use air and water entering the or each passage with air passing through the or each passage and being free to enter ambient air on the second side of the panel but water collecting in the or each passage pocket.

Preferably the panel is formed from a plurality of vertical baffles in a side by side relationship with passages formed therebetween. Preferably the vertical baffles are of identical shape. Preferably the baffles overlap one another. Preferably the panel is substantially planar.

Preferably the or each passage is non-linear. Preferably the or each passage has two changes of direction. Preferably pockets are positioned generally at a tangent to the change of direction in the passages.

The or each pockets may be a channel running vertically down the baffles whereby water drains down each channel back onto the roadway. The channels may be generally U-shaped. In one embodiment three pockets are formed on each baffle.

An embodiment of the invention will now be described with reference to the accompanying drawings in which:

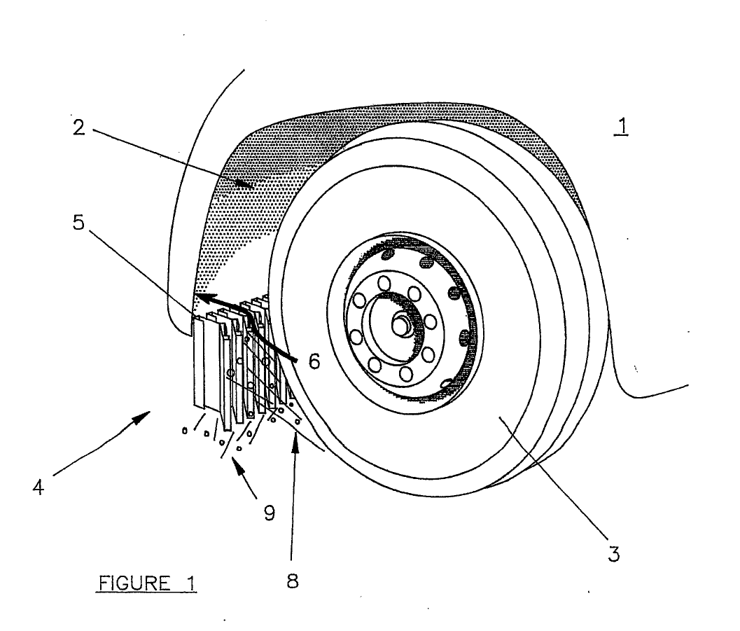

FIG. 1 shows a perspective view of the wheel arch of a road vehicle with the device fitted,

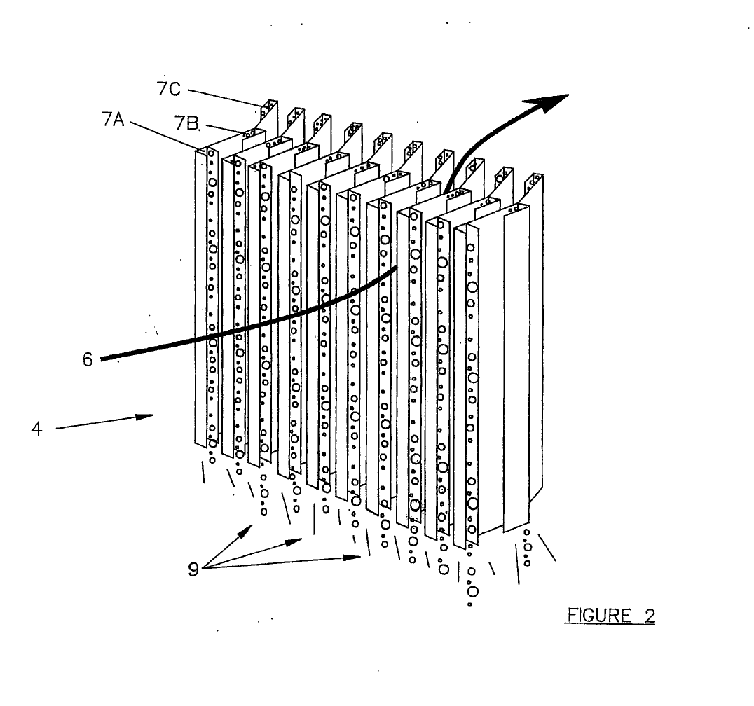

FIG. 2 shows an enlarged view of FIG. 1,

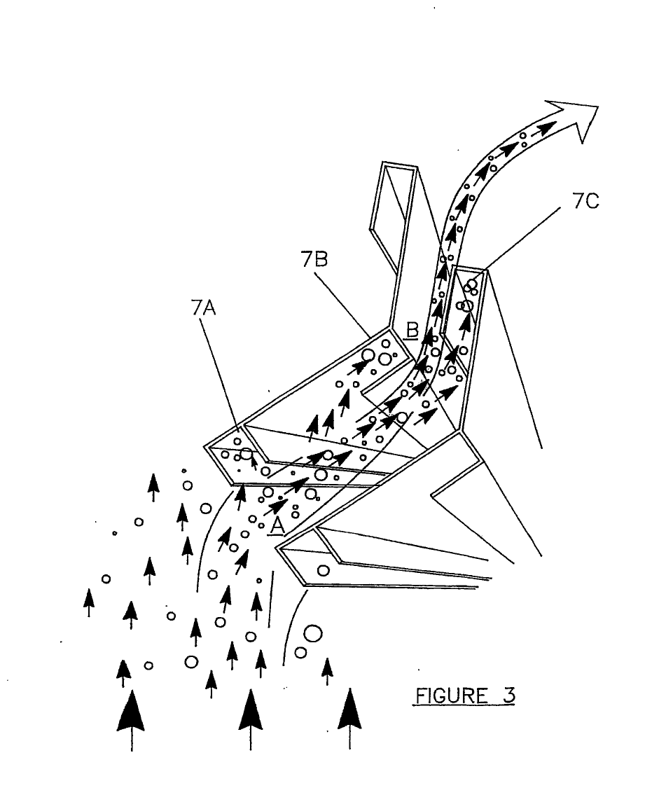

FIG. 3 shows a section of FIG. 1 showing in schematic form the flow of air and spray there through; and

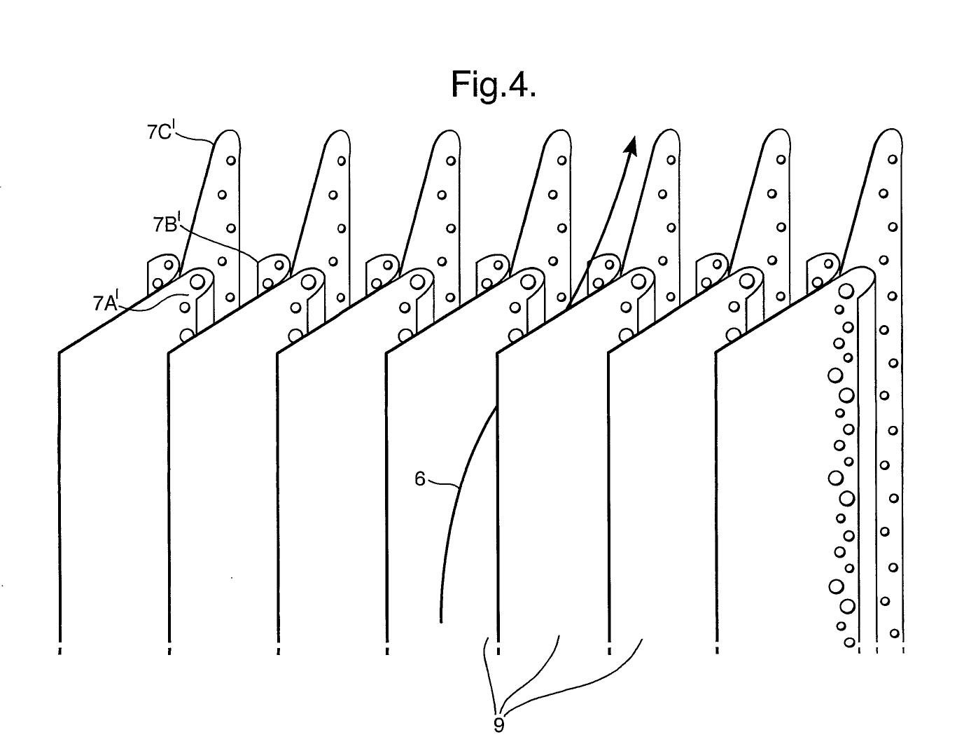

FIG. 4 shows a perspective view of an alternative configuration of the device.

Referring to FIG. 1 there is shown a vehicle 1 with a wheel arch 2 over a wheel 3. Mounted below the wheel arch and between the wheel 3 and wheel arch 2 is a generally planar panel 4 made up from a plurality of identical baffles 5 with passages 6 leading from a first side of the panel through to a second side of the panel as shown more clearly in FIG. 2. Each baffle includes three water-collecting pockets in the form of vertical U-shaped channels 7A, 7B, 7C on the side of the passage 6. In use (as described more fully below) on wet road surfaces, water 8 is thrown up by the wheel onto the first side of the panel 4 and passes with air through the passage 6, but a substantial amount of the water is separated from the air by means of inertial forces and collected by channels 7A, 7B, 7C and falls as a stream of water 9 out of the bottom of the panel.

Referring now to FIGS. 2 and 3, it will be seen that the baffles 5 each overlap so that the passage takes a generally curvaceous path through the pane 4, i.e. the passage is not normal to the plane of the panel and is non-linear through the panel.

FIG. 3 shows a path of water and air being thrown at two of the baffles. As viewed, the left hand part of the path throws water and air into the first channel 7A where water will collect. The path then changes direction a first time as shown at “A” as it follows the passage 6. As it changes direction, because water is heavier than air, the water particles tend to follow a straight path and leave the air flow at a tangent thereto into pocket 7B located at a tangent to the change of direction of the passage. The path then changes direction a second time as shown at “B” as it exits passage 6 and much of the water not collected by pocket 7B will leave the air flow at a tangent into pocket 7C located at a tangent to the second change of direction of the passage 6. The air, with much reduced water content, exiting the passage 6 is free to mix with ambient air.

It has been found that good separation of water from air is achievable.

An alternative baffle arrangement is shown in FIG. 4. The U-shaped channels 7A′, 7B′, 7C′ have a rounded profile.

As water and air enter the passage 6 they change direction. The water, being the heavier component, tends to enter channel 7A′, while the air flows past. Any water that remains in the flow is caught in turn by channels 7B′ and 7C′ respectively as the stream is forced to change direction again.

It is envisaged that the panel may take a form different to those specifically described above. For example the passage through the panel may change direction only once or more than twice. The pockets may be other than U-shaped channels.

It is envisaged that such a panel may be formed by extruding the baffles, and joining the baffles in side by side relationship, e.g. with elongate horizontal shafts supporting spacers between baffles.

Further modifications will be apparent to those skilled in the art without departing from the scope of the present invention.

1. A device for preventing spray from emerging from the wheels of vehicles comprising a panel that is adapted to be mounted substantially vertically behind a vehicle wheel for receiving on a first side water released by the wheel as it rotates, the panel including at least one passage which leads from the first side to a rear second side of the panel, the or each passage being other than normal to the plane of the panel, and at least one water-collecting pocket along the side of the or each passage, wherein, in use, air and water entering the or each passage are separated so that air passes through the or each passage and mixes with ambient air on a second side of the panel, and water collects in the or each water-collecting pocket.

2. The device as claimed in claim 1, wherein the panel is formed from a plurality of vertical baffles in a side by side relationship with passages therebetween.

3. The device as claimed in claim 2, wherein the baffles are substantially identical in shape.

4. The device as claimed in claim 2, wherein the baffles overlap one another.

5. The device as claimed in claim 1, wherein the panel is substantially planar.

6. The device as claimed in claim 1, wherein the or each passage is non-linear.

7. The device as claimed in claim 1, wherein the water-collecting pockets are arranged so as to collect water following a change of direction in the or each passage.

8. The device as claimed in claim 7, wherein the or each passage has two changes of direction.

9. The device as claimed in claim 1, wherein the or each pocket is a channel running substantially vertically along its respective baffle, so that, in use, water drains from the baffles onto a surface on which the wheel is travelling.

10. The device as claimed in claim 9, wherein the channel is substantially U-shaped.

11. (canceled)

12. The device as claimed in claim 3, wherein the baffles overlap one another.
